(19) United States
(12) Patent Application Publication
(10) Pub. No.: US 2003/0234924 A1
(43) Pub. Date: Dec. 25, 2003

(54) Optical device measuring apparatus and light receiving unit available for such optical device measuring apparatus

(75) Inventor: Haruyoshi Ono, Yamanashi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU QUANTUM DEVICES LIMITED, Yamanashi (JP)

(21) Appl. No.: 10/463,806

(22) Filed: Jun. 18, 2003

(30) Foreign Application Priority Data
Jun. 21, 2002 (JP) NO. 2002-182089

(51) Int. Cl. G01J 1/42

(52) U.S. Cl. 356/218

(57) ABSTRACT

An optical device measuring apparatus includes a photodetector receiving light emitted from an optical device, and an introduction portion for introducing the emitted light transmitted through the photodetector to an optical fiber.

### BACKGROUND OF THE INVENTION

1. Field of the Invention

The present invention generally relates to a measuring technique for measuring light emitted (hereinafter referred to as emitted light) from an optical device, and more particularly, to a measuring apparatus in which absolute measurement, for example, for finding the total amount of the emitted light from an optical device and analytical measurement for finding parameters such as wavelengths and transmission characteristics indicating various characteristic features of light can be simultaneously executed.

2. Description of the Related Art

In measurement of light emitted from an optical device, such as an optical semiconductor device, it is important to determine how to capture light for test. In general, there are two ways to capture the emitted light. The first way is to measure light emitted from an optical semiconductor chip that is in a bare state. The second way is to measure light emitted from an optical module via an optical fiber extending from the module in which an optical semiconductor chip is accommodated.

There are two types of light measuring test. The first test measures the optical output (power). The second test measures parameters such as a spectrum, wavelength and a transmission characteristic. The first test is absolute measurement, and the second test is analytical measurement. It is possible to obtain all characteristic features of the emitted light through the two types of test.

One of the above two light measuring tests is absolute, and the other is analytical. Since purposes of the two light measuring tests completely differ from each other, measuring manners and measuring mechanisms completely differ from each other. Thus, in the conventional case, the two light measuring tests are separately executed at different times with measuring apparatuses, which may be in different places.

FIGS. 1 and 2 illustrate conventional measurements of the emitted light (laser light) from the optical semiconductor device. More particularly, FIG. 1 schematically shows a way of measuring parameters such as the transmission characteristics of the emitted light. In FIG. 1, emitted light 2 from an optical semiconductor chip 1, which is in the bare state, is introduced into an optical fiber 3. This way of measuring is used to check the parameter characteristics of the emitted light 2, such as the spectrum, the wavelength (the frequency), the transmission characteristics and the like. A condenser lens 4 is connected to an end of the optical fiber 3, and the light is adequately introduced into the condenser lens 4 by an automatic centering controller (not shown).

FIG. 2 schematically shows a way of catching the total amount of light in order to measure the output power of the emitted light 2. It is required to measure the absolute power of the light with a high reproducibility. In this case, the measurement is executed in the manner as shown in FIG. 2. In FIG. 2, the emitted light from the optical semiconductor chip 1 mounted in an optical module 5 travels through an optical system 6, an optical fiber 7 and an optical connector 8, so that a photodetector (PD) 10, functioning as a light receiving device, receives the approximately total amount of the light.

Besides the measurements shown in FIGS. 1 and 2, the total amount of the emitted light from the optical semiconductor chip 1 which is in a bare state may be measured using the photodetector (PD) 10. The emitted light output from the ferrule 9 may be introduced into the optical fiber 3.

Further, FIGS. 3 and 4 illustrate conventional measuring apparatuses for measuring the emitted light from a laser chip 11 that is a semiconductor device in the bare state.

In the measuring apparatus shown in FIG. 3, laser light emitted from the laser chip 11 mounted on a carrier 12 is introduced into an optical fiber 13 to which a condenser lens 14 is attached. The laser light introduced into the optical fiber 13 is supplied to a light power measuring unit 15 and a light wavelength measuring unit 16 through an optical switch (optical SW) and supplied to a transmission characteristic evaluating apparatus 17. In the measuring apparatus shown in FIG. 3, analytical tests for measuring light transmission characteristics, such as a wavelength characteristic, a digital transmission characteristic and an analog transmission characteristic, are executed. In this case, the amount of light introduced into the optical fiber 13 is generally limited to several tens percents of the total amount of the light. The amount of the light supplied to the light power measuring unit 15 is an absolute value.

In addition, in the measuring apparatus shown in FIG. 4, a photodiode 18 functioning as the light receiving device is located so that it can receive the approximately total amount of the laser light emitted from the laser chip 11. Output from the photodiode 18 is supplied to a light-electric (I-L) measuring unit 19.

Using the measuring apparatus shown in FIG. 4, the important test for measuring an optical output characteristic is executed. In this test, it is necessary to evaluate the output of the light as an absolute value, and the reproducibility of the measurement is important. This measuring apparatus is set so that the approximately total amount of the laser light can be received in a constant condition.

In the conventional case where the light measurement is executed using the above two measuring apparatuses, the test for measuring the absolute power of the light and the test for measuring the various characteristics such as the light wavelength and the like are completely separated as described above. Thus, test processes are separately set-up, and the measurement is executed by using the different testing apparatuses as shown in FIG. 3 and FIG. 4.

However, in a case where the both tests for evaluating the optical device are separately executed as described above, it is difficult to accelerate rationalizing and automating the test processes and decreasing the number of processes. In addition, although the accuracy of the one test can be improved by use of measurement data obtained in the other test, since the apparatuses used in the both tests are separated, it is difficult to handle the measurement data. As a result, the evaluation of the optical device needs a long time and much cost.

### SUMMARY OF THE INVENTION

It is a general object of the present invention to provide an optical device measuring apparatus in which the above problems are eliminated.

A more specific object of the present invention is to provide an optical measuring apparatus capable of efficiently measuring characteristics of emitted light from an optical device.

According to an aspect of the present invention, there is provided an optical measuring apparatus comprising: a photo detecting device for receiving light emitted from an optical device; and an introduction portion for introducing the emitted light transmitted through the photo detecting device to an optical fiber.

The optical fiber and the introduction portion may be optically and directly connected. The introduction portion may have a condenser lens. The optical device measuring apparatus may further comprise at least a first lens and a second lens, the first lens being arranged in front of the light detecting device and converting the emitted light to collimated light, and the second lens condensing the collimated light transmitted through the optical detecting device to the introduction portion. In this case, an isolator for antireflection may be arranged between the photo detecting device and the second lens. Characteristics of the emitted light may be measured using output of the photo detecting device and the output the optical fiber. In a case where the output of the photo detecting device and the output of the optical fiber can be simultaneously measured, one output data may be used for correcting other output data. Thus, advanced measurement can be executed. A photoelectric output characteristic may be obtained based on the output of the photo detecting device, and a transmission characteristic may be obtained based on the output of the optical fiber. Wavelength data obtained based on the output of the optical fiber may be used for compensation of wavelength sensibility of the photo detecting device or for a wavelength process. In a case where the optical device is mounted in an optical module, the optical device measuring apparatus further may comprise a temperature control unit for controlling temperature of the optical device.

According to an aspect of the present invention, there is provided a light receiving unit comprising: a photo detecting device for receiving light emitted from an optical device; and an introduction portion for introducing the emitted light transmitted through the photo detecting device to an optical fiber.

According to an aspect of the present invention, there is provide a method for measuring light emitted from an optical device, comprising the steps of: measuring an absolute characteristic of the emitted light; and measuring a parameter characteristic of the emitted light, wherein the steps are continuously executed.

According to an aspect of the present invention, there is provided a method for measuring light emitted from an optical device, comprising the steps of measuring an absolute characteristic of the emitted light; and measuring a parameter characteristic of the emitted light, wherein the steps are simultaneously executed.

### BRIEF DESCRIPTION OF THE DRAWINGS

Other objects, features and advantages of the present invention will become more apparent from the following detailed description when read in conjunction with the accompanying drawings, in which:

FIG. 1 is a diagram schematically illustrating a state where transmission characteristics of emitted light are measured in a conventional case;

FIG. 2 is a diagram schematically illustrating a state where the total amount of light is caught in order to measure output power of emitted light in a conventional case;

FIG. 3 is a diagram illustrating a conventional measuring apparatus executing an analytical test;

FIG. 4 is a diagram illustrating a conventional measuring apparatus executing an absolute value output test;

FIGS. 5A and 5B are diagrams illustrating a typical configuration of a principal part of the present invention;

FIG. 6 is a diagram schematically illustrating a configuration of a light receiving unit used for optical device measurement according to a first embodiment of the present invention;

FIG. 7 is a diagram schematically illustrating a configuration of an optical device measuring apparatus having the light receiving unit shown in FIG. 6;

FIG. 8 is a diagram schematically illustrating a configuration of a light receiving unit used for the optical device measurement according to a second embodiment of the present invention;

FIG. 9 is a diagram illustrating a variation of the light receiving unit shown in FIG. 8;

FIG. 10 is a diagram schematically illustrating a configuration of an optical device measuring apparatus having the light receiving unit according to the second embodiment of the present invention;

FIG. 11 is a graph illustrating relationships between sensitivity of a photodetector and a parameter (WAVE LENGTH/ELECTRIC CURRENT); and

FIG. 12 is a block diagram illustrating a relationship between a wavelength tuning process and test processes in a conventional case where a multiple wavelength optical device is tested.

### DESCRIPTION OF THE PREFERRED EMBODIMENTS

A description will now be given of principles of the present invention.

FIGS. 5A and SB schematically illustrate a configuration of an embodiment of the present invention. FIG. 5A illustrates a conceptual configuration of the principle part of the present invention. FIG. 5B illustrates a practical configuration of the present invention.

In the common configuration of embodiments of the present invention described in the specification, as shown in FIG. 5A, a photodetector (PD) 22 having permeability is allocated so that it can receive the approximately total amount of emitted light 20. An optical fiber 24 is arranged behind the photodetector 22 (on a downstream side in a traveling direction of the emitted light 20). In this embodiment, as a preferable aspect, an introduction portion 25 having a condenser lens is attached to an end of the optical fiber 24. However, the optical fiber 24 and the introduction portion 25 may be optically and directly connected without using the condenser lens.

According to the above configuration, a static characteristic (an absolute value of optical output) can be measured through electrodes 23A and 23B connected to the photodetector 22. In addition, optical parameters such as a transmission characteristic and the like can be measured based on output of the optical fiber 24.

In FIG. 5B that illustrates a more preferable aspect, a collimate lens 28 (a first lens) is arranged on a ferrule 32 side of the photodetector 22, and a collimate condenser lens 29 (a second lens) is arranged between the photodetector 22 and the introduction portion 25. The collimate lens 28 in the configuration shown in FIG. 5B brings about the degree of freedom for changing the distance between a light source and the photodetector 22 can be obtained. In addition, since the collimate condenser lens 29 is provided on the downstream side of the introduction portion 25, the emitted light 20 can be efficiently introduced into the introduction portion 25.

In the configurations shown in FIGS. 5A and 5B, an emitted light from an optical semiconductor chip mounted in an optical module (not shown) is introduced into an optical connector 30 through an optical fiber 33. The light is emitted (the emitted light 20) from an end of the ferrule 32 of the optical connector 30.

As shown in FIGS. 5A and 5B, the approximately total amount of the emitted light 20 is received by the photodetector 22 and the introduction portion 25 located on the downstream side of the photodetector 22 receives the emitted light 20. Thus, the measuring tests that are separately executed conventionally can be successively or simultaneously executed. The absolute measurement of the optical output and the measurement of various optical characteristics can be executed by the same apparatus. Thus, the number of test processes can be decreased, so that the optical device can be efficiently evaluated. As a result, the optical device can be placed on market at low price.

In the case shown in FIG. 5B, both the first and second lenses 28 and 29 are employed. However, one of the lenses 28 and 29 may be omitted. In a case where the lens 28 is omitted, the photodetector 22 may be placed close to the ferrule 32 so that the total amount of the emitted light 20 can be received by the photodetector 22. Although the emitted light 20 is collimated in a case where the lens 29 is omitted, the introduction portion 25 can receive a predetermined amount of light, so that the measuring test can be executed.

Hereinafter, a description will be given of embodiments of the present invention with reference to the accompanying drawings.

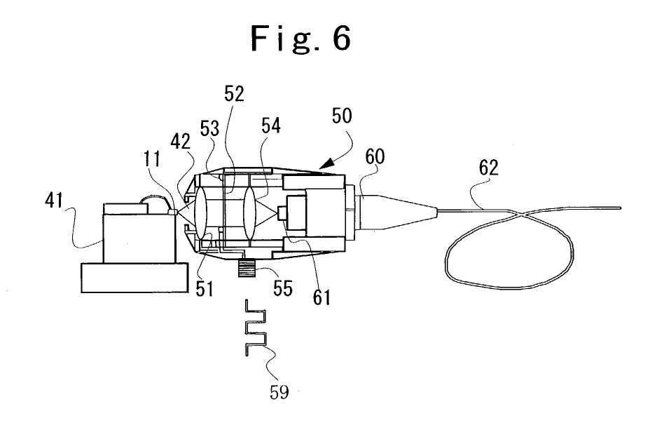

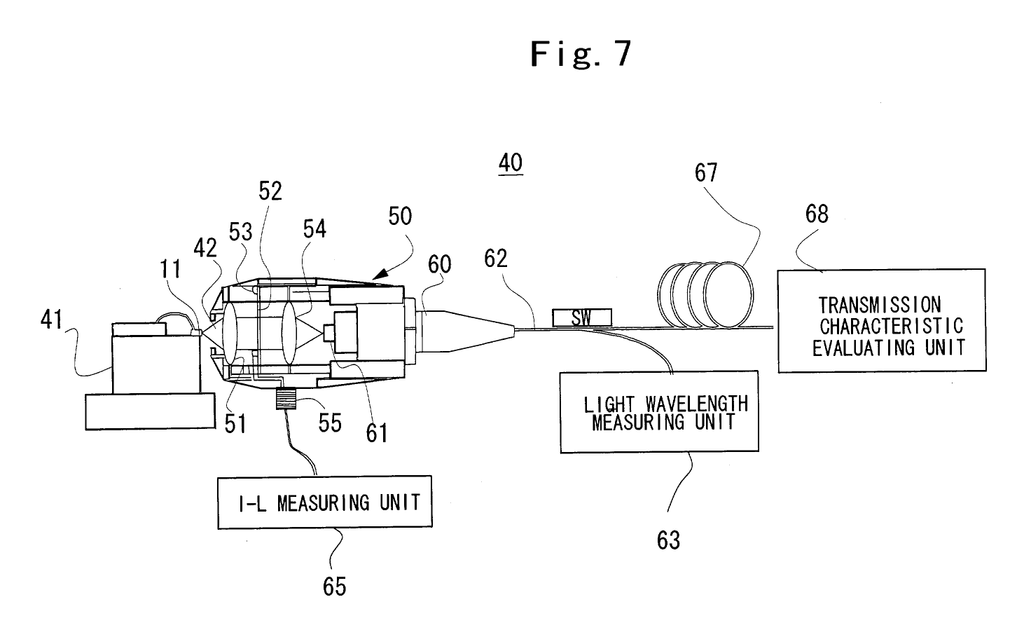

FIG. 6 schematically illustrates a configuration of a light receiving unit 50 used for optical device measurement according to a first embodiment of the present invention. FIG. 7 schematically illustrates a configuration of an optical device measuring apparatus having the light receiving unit 50. In the first embodiment, emitted light 42 from an optical semiconductor chip (a laser chip) 11 that is in a bare state is measured.

Referring to FIG. 6, in the light receiving unit 50, a collimate lens 51, a transmissive photodetector 52, and a collimate condenser lens 54 are arranged in this order. The collimate lens 51 transforms the emitted light (the laser light) from the front end (a left side end in FIG. 6) of the optical semiconductor device 11 to collimated light. The collimate condenser lens 54 condenses the collimated light transmitting through the transmissive photodetector 52. Terminals of the transmissive photodetector 52 are bonded with wires 53 so as to be electrically connected to a connector 55 formed on a peripheral portion of the light receiving unit 50. A light-electric (I-L) conversion signal 59 from the photodetector 52 is obtained through the connector 55. The laser light 42 is emitted from the laser chip 11, which is mounted at a predetermined position on a laser carrier 41. The light receiving unit 50 is arranged at a position where the laser light 42 can be received in the optimum condition.

In addition, a condensing and receiving portion 60 is provided to the light receiving unit 50 so as to block up a right end of the light receiving unit 50. A condenser lens 61 in the condensing and receiving portion 60 is arranged at a position where light condensed by the collimate condenser lens 54 is efficiently received by the condenser lens 61. The light received by the condenser lens 61 is supplied to an optical fiber 62. However, in this embodiment, the light may be directly and optically connected to an end of a general optical connector ferrule without using the condenser lens 61.

FIG. 7 schematically illustrates a configuration of a measuring apparatus 40 having the light receiving unit 50. The laser chip 11 is located at a predetermined position on the laser carrier 41. The laser chip 11 emits the laser light 42. The light receiving unit 50 is fixed at a position where the laser light 42 can be received by the light receiving unit 50 in the optimum condition. The I-L measuring unit 65 is connected to the connector 55 formed on the peripheral portion of the light receiving unit 50. A received signal (the photoelectric conversion signal) from the photodetector 52 is supplied to the I-L measuring unit 65 through the connector 55. A high-frequency connector capable of outputting high-frequency signals and modulated optical signals may be used as the connector 55. The light introduced by the condenser lens 61 is supplied to a light wavelength measuring unit 63 through the optical fiber 62 and an optical switch. The transmission dispersion of the light is compensated for by a fiber 67 for making the dispersion uniform, and the dispersion compensated light is supplied to a transmission characteristic evaluating apparatus 68.

According to the first embodiment of the present invention, the different types of test that should be separately executed in the conventional case can be executed in a lump. The measurement of the absolute value output of the light by the I-L measuring unit 65 and the measurement of the parameter characteristics by the transmission characteristic evaluating apparatus 68 are simultaneously executed, so that the efficiency of the tests can be improved.

In the measuring apparatus 40 according to this embodiment, the two types of test may be executed successively or at predetermined intervals.

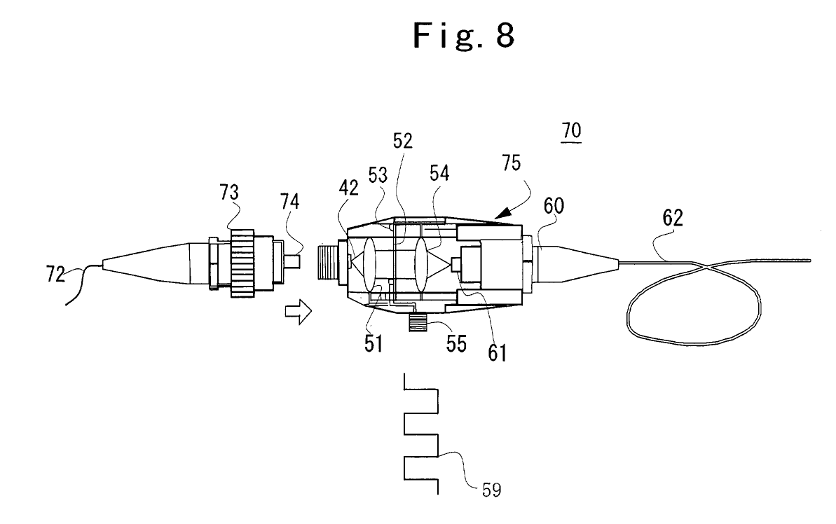

FIG. 8 schematically illustrates a configuration of a light receiving unit 70 used for optical device measurement according to a second embodiment of the present invention. The light receiving unit 50 employed in the first embodiment as described above directly receives the laser light from the laser chip 11. In contrast, the light receiving unit 70 employed in the second embodiment of the present invention receives the laser light from the laser chip mounted in an optical module through an optical fiber. In FIG. 8, those parts that are the same as those shown in FIG. 6 are given the same reference numbers, and the duplicated description thereof is avoided.

The light receiving unit 70 according to the present embodiment has a configuration in which an optical connector 73 is attached to the left side end of the light receiving unit 50 employed in the first embodiment. The optical connector 73, which is a male connector, is connected to the end of an optical fiber 72 extended from the optical module in which the laser chip is mounted. A right side portion (hereinafter, referred to as a light receiving main body 75), having the same configuration as that of the light receiving unit 50, of the light receiving unit 70 has a female component, which can be connected to the male optical connector 73. The laser light 42 is emitted from a ferrule 74 on the front end of the optical connector 73, and is introduced into the light receiving main body 75.

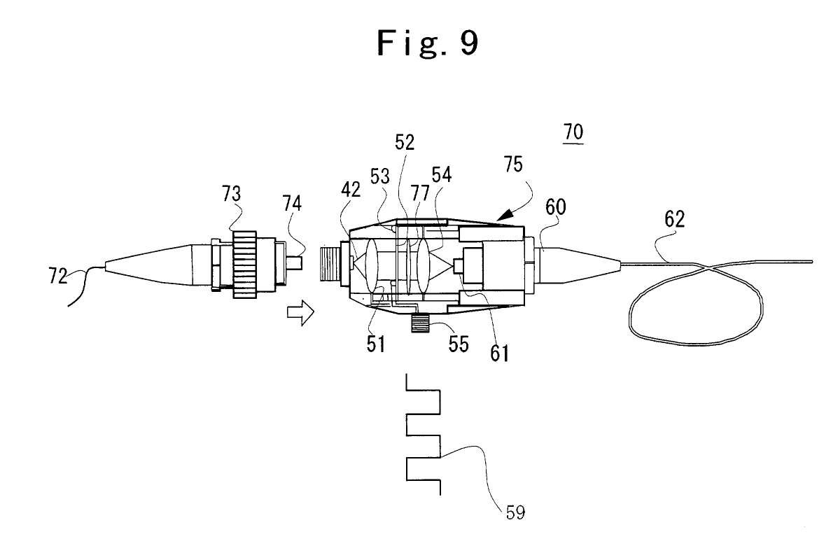

FIG. 9 illustrates a variation of the light receiving unit 70 shown in FIG. 8. The light receiving main body 75 in this variation has an isolator 77 for antireflection, which is arranged between the photodetector 52 and the collimate condenser lens 54. According to such a configuration, the homogeneous light can be supplied to the collimate condenser lens 54, so that the various parameter characteristics such as the transmission characteristic and the like may be measured more accurately.

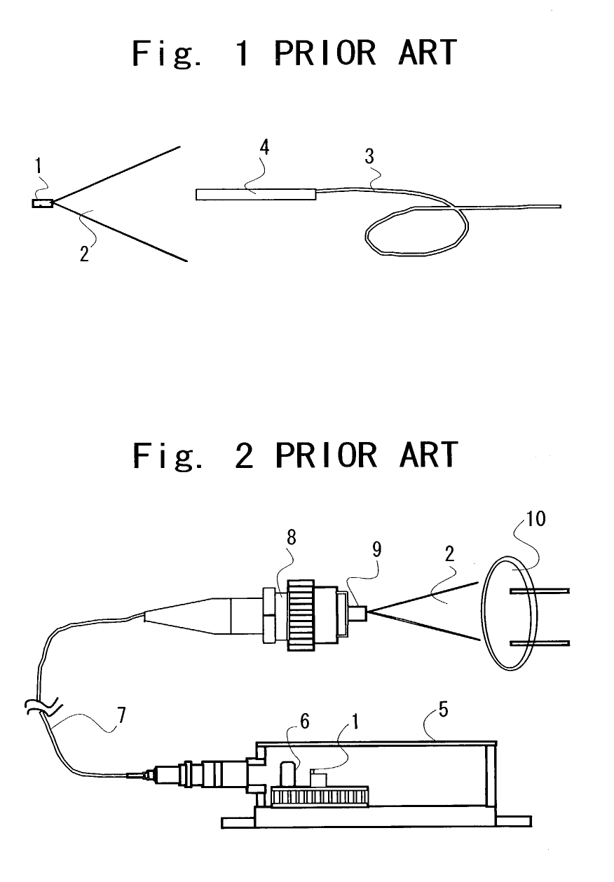

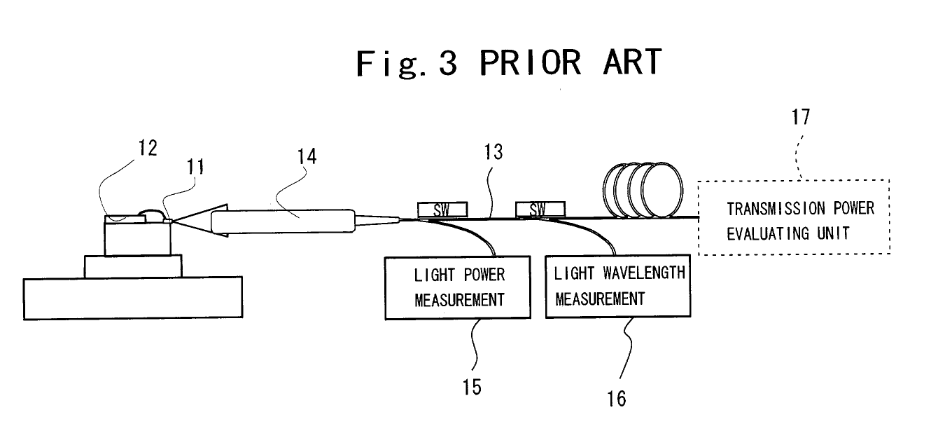

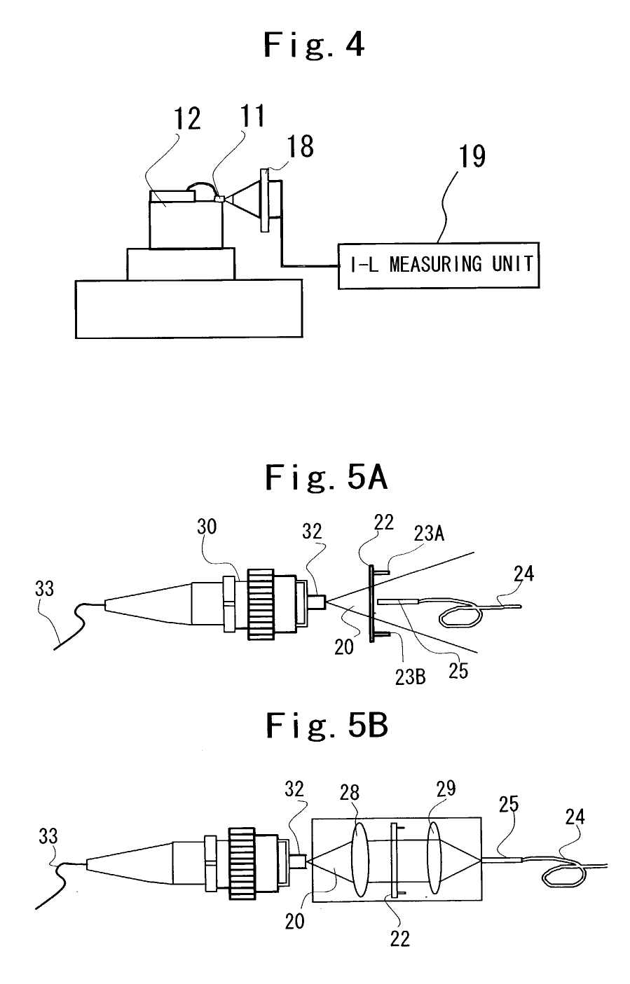

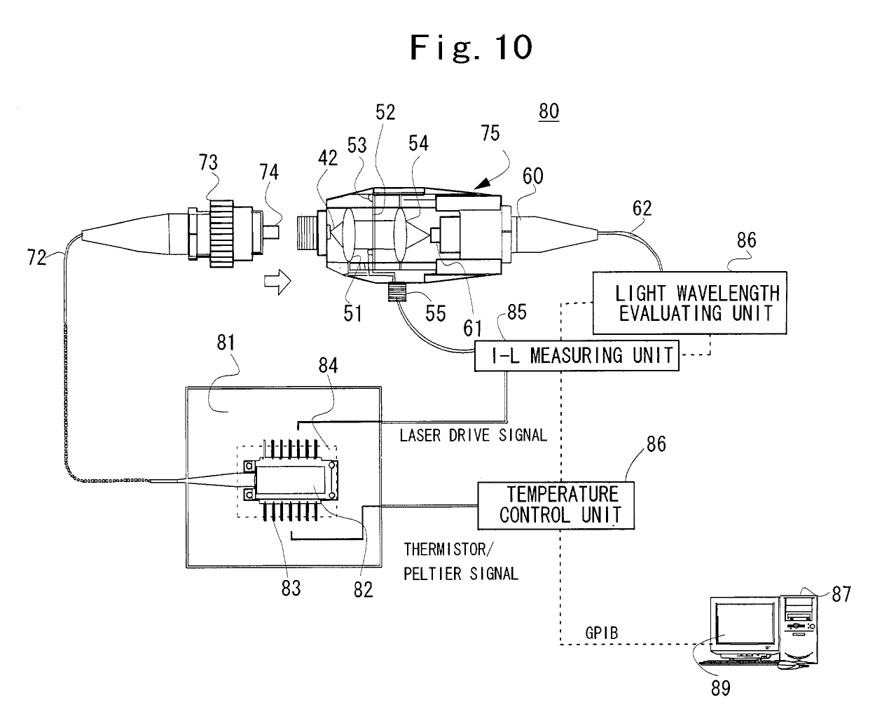

A description will be given, with reference to FIG. 10, of an optical device measuring apparatus 80 in which the light receiving unit 70 shown in FIGS. 8 and 9 is incorporated. FIG. 10 schematically illustrates a configuration of the optical device measuring apparatus 80. This measuring apparatus measures light from the optical module, like the conventional measuring apparatus shown in FIG. 2. The measuring apparatus 80 has an optical module 82 with an optical semiconductor chip (a laser chip), which is located at a center position of a base 81. A thermistor and a Peltier effect device 84 are mounted in the optical module 82, so that the temperature of the laser chip can be controlled. In addition, a plurality of terminals 83 are extracted from the optical module 82 and are connected to wiring lines (not shown) formed on the base 81. An I-L measuring unit 85 and a temperature control unit 87, which will be described later, are electrically connected to the optical module 82 via contacts between a printed circuit board (not shown) and the terminals 83 of the optical module 82.

The laser light from the optical module 82 travels to the optical connector 73 through the optical fiber 72 and is emitted from the end of the ferrule 74. The optical connector 73, which is the male connector, can be connected to the female component of the light receiving main body 75. As described above, the light receiving main body 75 has the same configuration as that of the light receiving unit 50 according to the first embodiment.

The measuring apparatus 80 is provided with a control computer 88 for controlling measuring operations in the measuring apparatus 80. The control computer 88 has a display unit 89 on which the control aspect is displayed. An operator can see the control aspect. The computer 88 totally controls the I-L measuring unit 85 for measuring the optical power, a light wavelength measuring unit 86 for measuring wavelength data of the light and a temperature control unit 87 for controlling the temperature of the optical module 82.

The I-L measuring unit 85 is connected to the printed circuit board (not shown) on the base 81 and the connector 55. The I-L measuring unit 85 supplies a laser drive signal to the optical module 82, which emits laser light. The I-L measuring unit 85 also receives a photoelectric conversion signal from the photodetector 52. The light wavelength measuring unit 86 receives the light from the condenser lens 61 through the optical fiber 62, and generates the wavelength data based on the received light. The wavelength data is supplied to the I-L measuring unit 85. The temperature control unit 87 drives the Peltier effect device 84 under control of the computer 88, so that the temperature of the laser chip in the optical module 82 is controlled within a predetermined range.

In the measuring apparatus 80, wavelength data can be obtained in real time while the I-L measurement is being executed. Thus, the absolute value of the light can be measured with a high sensitivity while effects due to the variation of the wavelength are being compensated for in the measurement.

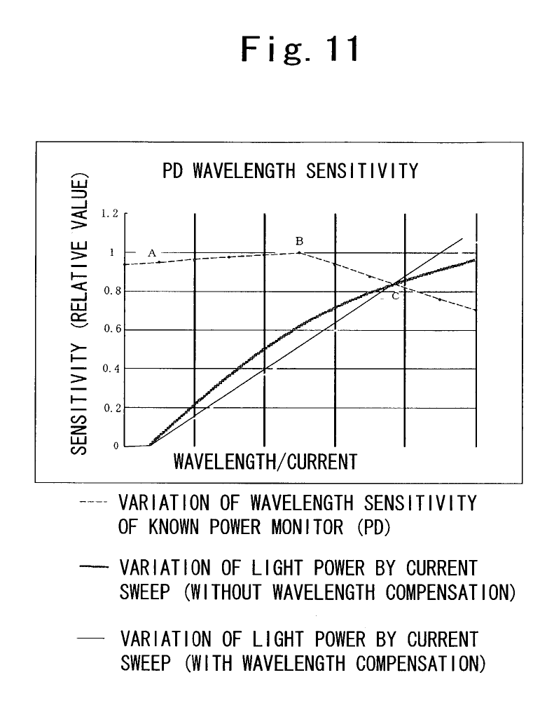

FIG. 11 illustrates the variation of the sensitivity of the photodetector 52 with respect to a parameter (WAVE LENGTH/ELECTRIC CURRENT). Due to variation (increasing) of a laser current (an electric current) supplied to the laser chip, the optical output goes up, and a laser oscillation wavelength varies in a long wavelength direction. In this case, a wavelength sensitivity of the photodetector 52 continuously varies from a point A to a point C through a point B as shown in FIG. 11. That is, due to the variation of the current density based on the laser sweep, the wavelength of the laser light varies, so that the measurement accuracy of the light power is lowered.

In contrast, in the case of the measuring apparatus according to the embodiments of the present invention, the variation of the wavelength can be followed with a high responsibility while the absolute value of the light power is being measured, so that the variation of the wavelength based on the increase of the current density can be caught in real time. Due to compensating a calculated value of the light power using the known wavelength sensitivity data that has been memorized, the power measurement independent of the variation of the oscillation wavelength can be executed with a high accuracy.

In recent years, the semiconductor laser tends to increase output power. In the circumstances, the measuring apparatus of the present embodiment that measures the absolute value of the light power with executing the compensation process is useful to specify the absolute value of the light power with a high accuracy.

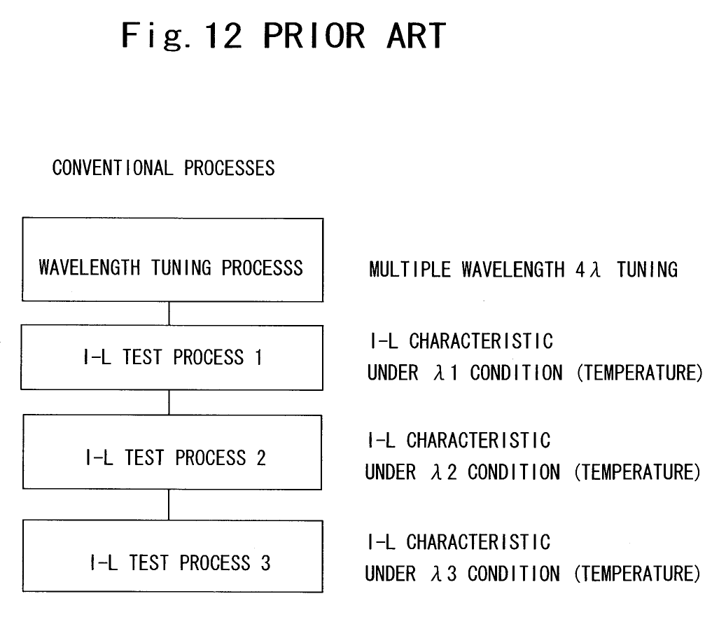

In addition, in a conventional case, when a multiple wavelength optical device is used, the I-L test process is executed for each of the multiple wavelengths (four wavelengths in a case shown in FIG. 12) after a wavelength tuning process is executed by another apparatus. In contrast, the measuring apparatus of the present embodiment can execute the I-L measurement with obtaining the wavelength data at need. Thus, there are advantages that the test processes can be simplified and measurement results with a high accuracy can be obtained.

In addition, a monitoring photodetector (PD) is mounted in the laser module in general. A signal (Im) from the monitoring photodetector (PD) is fed back to a laser drive current so that the output power is controlled to a constant level. This control is referred to as an Im-APC control. In the wavelength tuning process in the multiple wavelength laser, the inside temperature of the module is controlled with executing the Im-APC control so that the wavelength is tuned to a target wavelength. However, even if the control of the monitor current is uniform, the output power may be changed from that obtained at a start of the Im-APC control due to an actual variation of the inside temperature. To eliminate such a problem, the variation of the output power measured under the Im-APC control is checked using a reference, and a non-defective optical device is sorted based on the checking result. Thus, the reliability of the optical device may be improved. According to the measuring apparatus of the present embodiment as described above, the non-defective optical device can be sorted with executing the wavelength tuning process.

According to the present invention, the optical measuring tests of the emitted light from the optical device which should be separately executed can be executed by a single apparatus. Thus, the measuring tests can be efficiently executed.

Further, the measurement data obtained in one test can be easily used in another test, and the light power can be measured with compensating or controlling the measurement data. Thus, the reliability of the measurement can be improved.

The present invention is not limited to the specifically disclosed embodiments, and other embodiments, variations and modifications may be made without departing from the scope of the present invention.

The present invention is based on Japanese patent application no. 2002-182089 filed on Jun. 21, 2002, the entire disclosure of which is hereby incorporated by reference.

What is claimed is:

1. An optical device measuring apparatus comprising:
a photo detecting device for receiving light emitted from an optical device; and
an introduction portion for introducing the emitted light transmitted through the photo detecting device to an optical fiber.

2. The optical device measuring apparatus as claimed in claim 1, wherein the introduction portion and the optical fiber are optically and directly connected.

3 The optical device measuring apparatus as claimed in claim 1, wherein the introduction portion has a condenser lens.

4. The optical device measuring apparatus as claimed in claim 1 further comprising at least one of a first lens and a second lens,
the first lens being arranged in front of the light detecting device and converting the emitted light to collimated light, and
the second lens condensing the collimated light transmitted through the optical detecting device to the introduction portion.

5. The optical device measuring apparatus as claimed in claim 4 further comprising an isolator for antireflection arranged between the photo detecting device and the second lens.

6. The optical device measuring apparatus as claimed in claim 1, wherein characteristics of the emitted light are measured using output of the photo detecting device and output of the optical fiber.

7. The optical device measuring apparatus as claimed in claim 6, wherein the photo detecting device and the optical fiber are arranged so that the output of the photo detecting device and the output of the optical fiber can be simultaneously measured.

8. The optical device measuring apparatus as claimed in claim 7, wherein a photoelectric output characteristic is obtained based on the output of the photo detecting device, and wherein a transmission characteristic is obtained based on the output of the optical fiber.

9. The optical device measuring apparatus as claimed in claim 8, wherein wavelength data obtained based on the output of the optical fiber is used for compensation of wavelength sensibility of the photo detecting device or for a wavelength tuning process.

10. The optical device measuring apparatus as claimed in claim 1, wherein the optical device is mounted in an optical module, and wherein the optical device measuring apparatus further comprises a temperature control unit for controlling temperature of the optical device.

11. A light receiving unit comprising:
a photo detecting device for receiving light emitted from an optical device; and
an introduction portion for introducing the emitted light transmitted through the photo detecting device to an optical fiber.

12. The light receiving unit as claimed in claim 11 further comprising at least one of a first lens and a second lens,
the first lens being arranged in front of the light detecting device and converting the emitted light to a collimated light, and
the second lens condensing the collimated light transmitted through the optical detecting device.

13. The light receiving unit as claimed in claim 12, wherein the introduction portion is located at a position to which the collimated light is condensed.

14. The light receiving unit as claimed in claim 12, wherein the first lens directly receives the emitted light from the optical device.

15. The light receiving unit as claimed in claim 12, wherein the first lens receives the emitted light from the optical device mounted in an optical module through an optical fiber.

16. The light receiving unit as claimed in claim 12, further comprising an isolator for antireflection arranged between the photo detecting device and the second lens.

17. A method for measuring light emitted from an optical device, comprising the steps of:
measuring an absolute characteristic of the emitted light; and
measuring a parameter characteristic of the emitted light, wherein the steps are continuously executed.

18. The method as claimed in claim 17, wherein a total amount of the emitted light is measured as the absolute characteristic, and wherein a transmission characteristic of the emitted light is measured as the parameter characteristic.

19. A method for measuring light emitted from an optical device, comprising the steps of:
measuring an absolute characteristic of the emitted light; and
measuring a parameter characteristic of the emitted light, wherein the steps are simultaneously executed.

20. The method as claimed in claim 19, wherein a total amount of the emitted light is measured as the absolute characteristic, and wherein a transmission characteristic of the emitted light is measured as the parameter characteristic.

21. The method as claimed in claim 20, wherein data obtained by measuring the transmission characteristic is used for correction of measurement data obtained by measuring the total amount of the emitted light.
